(19) United States
(12) Patent Application Publication
(10) Pub. No.: US 2026/0106264 A1
(43) Pub. Date: Apr. 16, 2026

(54) BATTERY PACK

(71) Applicants: Hyundai Motor Company, Seoul (KR); Kia Corporation, Seoul (KR)

(72) Inventors: Kyung Mo KIM, Hwaseong-si (KR); Jong Gu LEE, Hwaseong-si (KR); Jun Su LEE, Hwaseong-si (KR); Si Won KIM, Hwaseong-si (KR); Gun Woo KO, Hwaseong-si (KR)

(73) Assignees: Hyundai Motor Company, Seoul (KR); Kia Corporation, Seoul (KR)

(21) Appl. No.: 19/275,550

(22) Filed: Jul. 21, 2025

(30) Foreign Application Priority Data
Oct. 11, 2024 (KR) 10-2024-0138948

(51) Int. Cl. H01M 10/6557; H01M 10/613; H01M 10/6567; H01M 50/204; H01M 50/242; H01M 50/249; H01M 50/271; H01M 50/289

(52) U.S. Cl. CPC H01M 10/6557; H01M 10/613; H01M 10/6567; H01M 50/242; H01M 50/249; H01M 50/271; H01M 50/289; H01M 50/204

(57) ABSTRACT

A battery pack includes a base cover, a plurality of battery cells contacting with the base cover, and a plate which is disposed between the plurality of battery cells and that includes a plate channel through which cooling water flows, and the plate channel includes a first heat-exchange area that exchanges heat with the base cover and a second heat-exchange area which is disposed below the first heat-exchange area and that exchanges heat with the battery cells.

### CROSS-REFERENCE TO RELATED APPLICATION

The present application claims the benefit of priority to Korean Patent Application No. 10-2024-0138948, filed in the Korean Intellectual Property Office on Oct. 11, 2024, the entire contents of which are incorporated herein by reference.

### TECHNICAL FIELD

The present disclosure relates to a battery pack.

### BACKGROUND

In recent years, research and development on electric vehicles, which are environment-friendly vehicles, has been emphasized as crisis awareness of environments and oil resource depletion has increased. The electric vehicles include a plug-in hybrid electric vehicle (PHEV), a battery electric vehicle (BEV), a fuel cell electric vehicle (FCEV), and the like.

An electric vehicle may include a battery housing that supports battery cells. Meanwhile, the electric vehicle utilizes the battery cells as a power source, and it is necessary to adjust the temperature of the battery cells to ensure the performance of the electric vehicle.

Furthermore, since a thermal runaway phenomenon occurs when the temperature of the battery cells rises so that a fire occurs inside the electric vehicle, it is necessary to prevent the thermal runaway phenomenon. Accordingly, to this end, the need for a battery pack structure capable of controlling the temperature of the battery cells is increasing.

### SUMMARY

The present disclosure has been made to solve the above-mentioned problems occurring in the related art while advantages achieved by the related art are maintained intact.

An aspect of the present disclosure provides a battery pack for automatically circulating cooling water using a difference in density depending on temperature through a plate channel on a plate disposed between battery cells.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery pack includes a base cover, a plurality of battery cells contacting with the base cover, and a plate which is disposed between the plurality of battery cells and that includes a plate channel through which cooling water flows, and the plate channel includes a first heat-exchange area that exchanges heat with the base cover and a second heat-exchange area which is disposed on an one side of the first heat-exchange area in an up-down direction of the plate and that exchanges heat with the battery cells.

The plate channel may be formed to be a closed passage through which the cooling water circulates.

The first heat-exchange area may include one end portion located on an upstream side of the first heat-exchange area with respect to a flow direction of the cooling water and an opposite end portion located on a downstream side of the first heat-exchange area with respect to the flow direction of the cooling water, and the opposite end portion of the first heat-exchange area may be disposed on an one side of the one end portion of the first heat-exchange area in the up-down direction of the plate.

The second heat-exchange area may include one end portion located on an upstream side of the second heat-exchange area with respect to a flow direction of the cooling water and an opposite end portion located on a downstream side of the second heat-exchange area with respect to the flow direction of the cooling water, and the opposite end portion of the second heat-exchange area may be disposed on an one side of the one end portion of the second heat-exchange area in the up-down direction of the plate.

The battery pack may further include a side member that covers one side of the plurality of battery cells, and the first heat-exchange area may be disposed closer to the side member than the second heat-exchange area on the plate.

The battery pack may further include a cross member which is contacting with the base cover and that extends to cross a space in which the plurality of battery cells are disposed, and the second heat-exchange area may be disposed closer to the cross member than the first heat-exchange area on the plate.

The side member may be disposed in a pair, and the battery pack may further include a cross member which is disposed between the pair of side members and that extends to cross a space in which the plurality of battery cells is disposed. The plurality of batter cells may include a first plurality of battery cells disposed between one of the pair of side members and the cross member and a second plurality of battery cells disposed between the other one of the pair of side members and the cross member. The plate channel of the plate disposed between the first plurality of battery cells and the plate channel of the plate disposed between the second plurality of battery cells may be disposed to be symmetrical to each other with respect to the cross member.

The plate channel may further include a first connection area that connects the one end portion of the first heat-exchange area and the second heat-exchange area and a second connection area that connects the opposite end portion of the first heat-exchange area and the second heat-exchange area.

The first connection area may extend in a horizontal direction thereof.

The second connection area may include a portion that extends in an oblique direction from the opposite end portion of the first heat-exchange area to the second heat-exchange area to form predetermined angles with a longitudinal direction of the plate and the up-down direction of the plate.

The first heat-exchange area may include a portion including a meandering shape in the up-down direction of the plate or a longitudinal direction of the plate.

The second heat-exchange area may include a portion including a meandering shape in the up-down direction of the plate or a longitudinal direction of the plate.

The first heat-exchange area may include a portion extending from one end portion thereof in a longitudinal direction of the plate toward an opposite end portion thereof in the longitudinal direction of the plate on the plate.

The second heat-exchange area may include a portion that extends from one end portion thereof in a longitudinal direction of the plate toward an opposite end portion thereof in the longitudinal direction of the plate on the plate.

The second heat-exchange area may extend from one end portion thereof in a longitudinal direction of the plate to an opposite end portion thereof in the longitudinal direction of the plate in a shape meandering in the up-down direction on the plate.

The base cover may be disposed on an one side of the plate channel in the up-down direction of the plate.

The base cover may include a base channel formed therein.

The battery pack may further include surface pressure members disposed between the plurality of battery cells and supporting the battery cells.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a battery pack disposed in an electric vehicle according to an exemplary embodiment of the present disclosure.

FIG. 2 is an exploded perspective view of the battery pack according to an exemplary embodiment of the present disclosure.

FIG. 3 is a perspective view of a battery cell stack according to an exemplary embodiment of the present disclosure.

FIG. 4 is an exploded perspective view of the battery cell stack according to an exemplary embodiment of the present disclosure.

FIG. 5 is a perspective view of a base cover and the battery cell stack according to an exemplary embodiment of the present disclosure.

FIG. 6 is a front view of a plate according to an exemplary embodiment of the present disclosure.

FIG. 7 is a front view of a plate according to another embodiment of the present disclosure.

FIG. 8 is a front view of a plate according to another embodiment of the present disclosure.

FIG. 9 is a front view of a plate according to another embodiment of the present disclosure.

FIG. 10 is a front view of a plate according to another embodiment of the present disclosure.

FIG. 11 is a vertical sectional view of the battery pack taken along line A-A′ illustrated in FIG. 1.

FIG. 12 is a vertical sectional view of the battery pack taken along line perpendicular to line A-A′ illustrated in FIG. 1.

### DETAILED DESCRIPTION

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, include the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

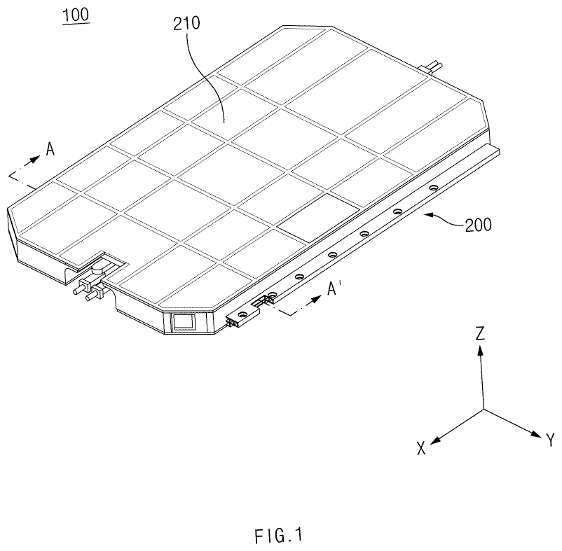

Hereinafter, embodiments of the present disclosure will be described in detail with reference to FIGS. 1 to 12. A first direction, a second direction, and a third direction below may be directions perpendicular to one another.

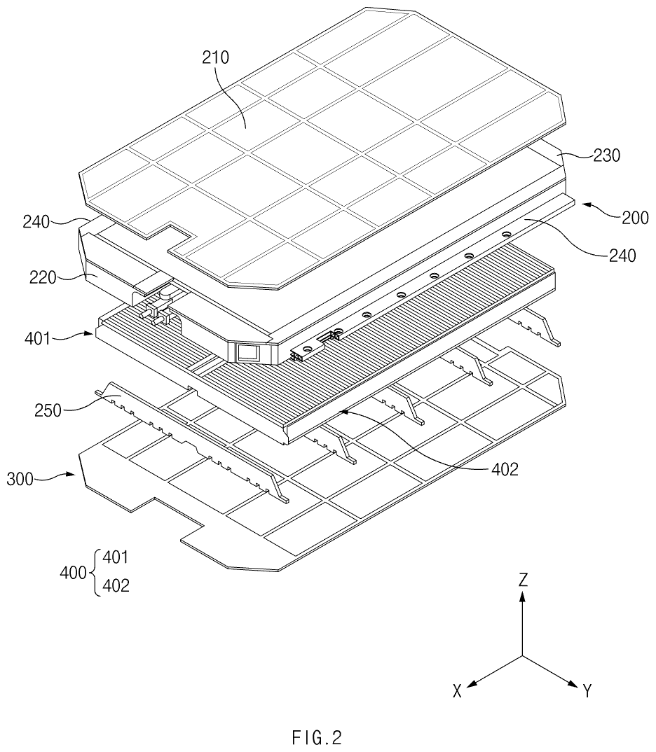

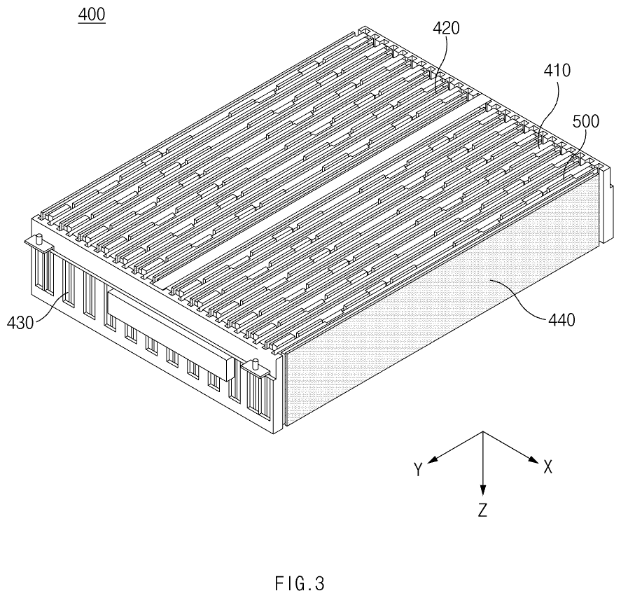

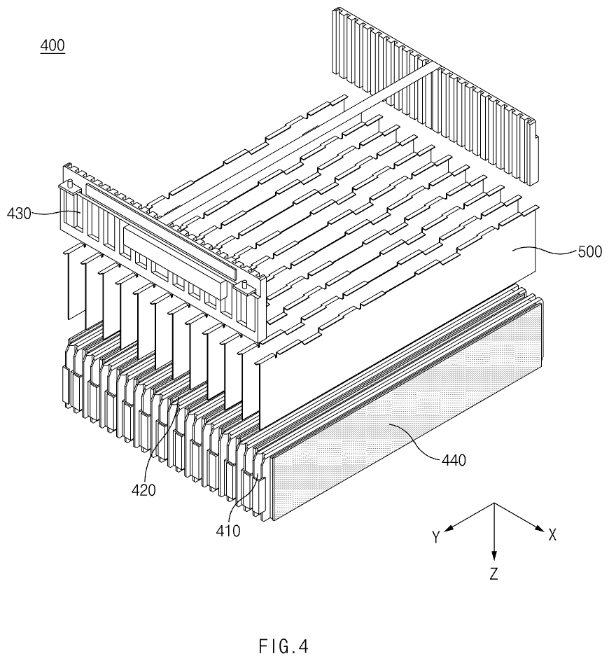

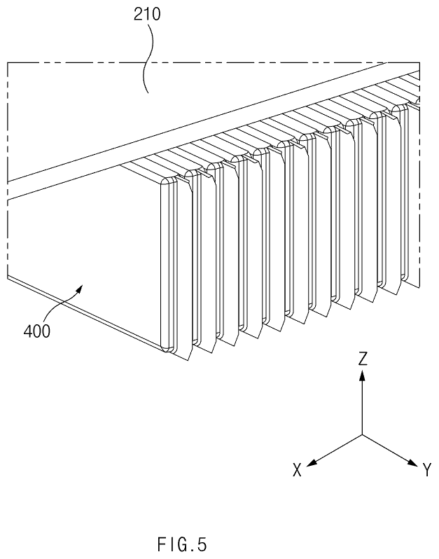

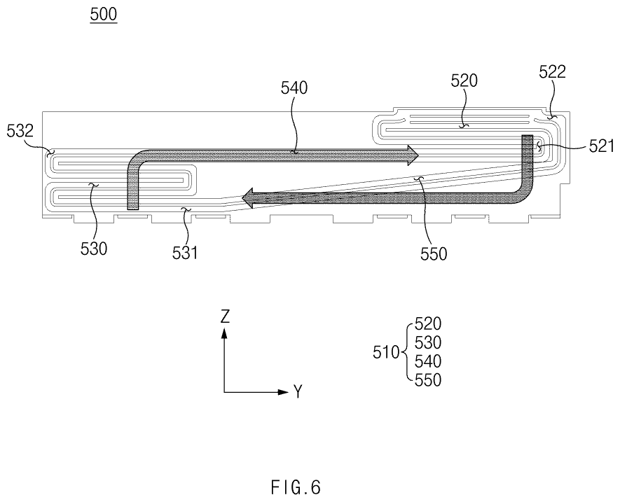

FIG. 1 is a perspective view of a battery pack disposed in an electric vehicle according to an exemplary embodiment of the present disclosure. FIG. 2 is an exploded perspective view of the battery pack according to an exemplary embodiment of the present disclosure. FIG. 3 is a perspective view of a battery cell stack according to an exemplary embodiment of the present disclosure. FIG. 4 is an exploded perspective view of the battery cell stack according to an exemplary embodiment of the present disclosure. FIG. 5 is a perspective view of a base cover and the battery cell stack according to an exemplary embodiment of the present disclosure. FIG. 6 is a front view of a plate according to an exemplary embodiment of the present disclosure.

Referring to FIGS. 1 to 6, the battery pack 100 may include a battery housing 200, a pack cover 300 coupled with the battery housing 200, and battery cell stacks 400 disposed in the battery housing 200.

The battery housing 200 may define a space in which the battery cell stacks 400 are accommodated. The battery housing 200 may include the base cover 210, a front member 220, a rear member 230, side members 240, partition members 250, and cross members 260.

The base cover 210 may support the battery cell stacks 400. The base cover 210 may include a base channel 211 through which cooling water flows.

The front member 220 may be supported by the base cover 210 and may cover areas of the battery cell stacks 400 that face toward one side in the first direction (face in an X direction). The rear member 230 may be supported by the base cover 210 and may cover areas of the battery cell stacks 400 that face toward an opposite side in the first direction (face in a direction opposite to the X direction).

The side members 240 may be disposed on opposite sides of the base cover 210 in the second direction (in a Y direction or a direction opposite to the Y direction) and may be supported by the base cover 210. The side members 240 may be disposed in a pair and may cover opposite sides of the battery cell stacks 400 in the second direction (in the Y direction or the direction opposite to the Y direction). The pair of side members 240 may cover opposite areas of the battery cell stacks 400 in the second direction (in the Y direction or the direction opposite to the Y direction).

The partition members 250 may be disposed between the front member 220 and the rear member 230. The partition members 250 may extend in the second direction (in the Y direction or the direction opposite to the Y direction) between the front member 220 and the rear member 230.

The partition members 250 may be disposed between the plurality of battery cell stacks 400 and may support the battery cell stacks 400. Each of the partition members 250 may define spaces in which a pair of battery cells stacks 400 disposed parallel to each other in the first direction (in the X direction or the direction opposite to the X direction) are accommodated. The partition members 250 may be spaced apart from one another in the first direction (in the X direction or the direction opposite to the X direction).

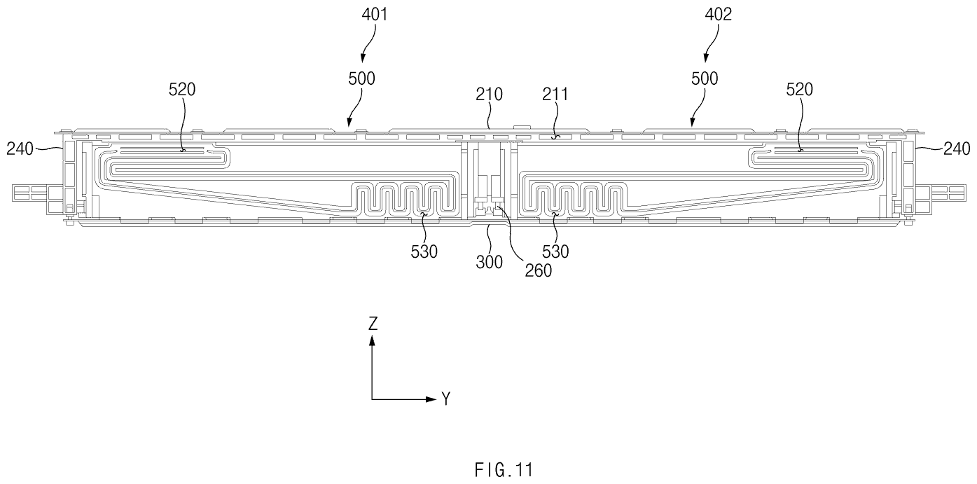

The cross members 260 (refer to FIG. 11) may be disposed between the pair of side members 240 and may extend from the rear member 230 toward the front member 220. Each of the cross members 260 may be disposed between a pair of partition members 250 adjacent to each other.

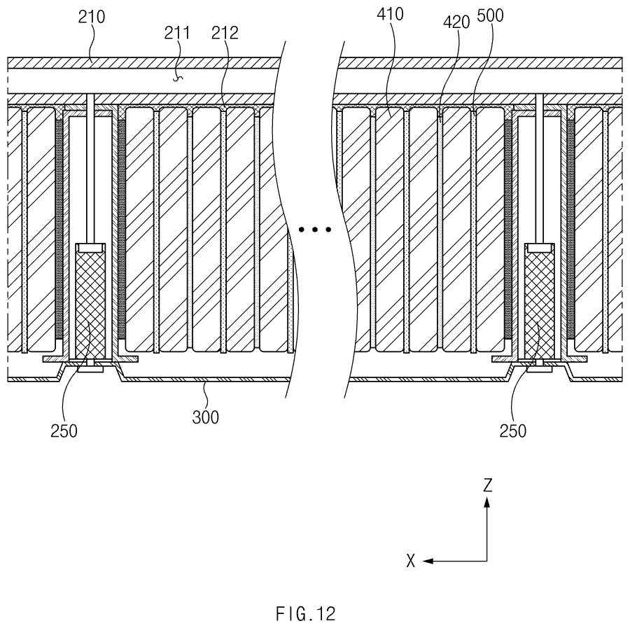

The cross members 260 may be contacting with the base cover 210 and may extend to cross the spaces in which the plurality of battery cell stacks 400 are disposed. The cross members 260 and the partition members 250 may extend in directions perpendicular to each other. Gap fillers 212 (refer to FIG. 12) may be disposed on areas of the base cover 210 divided from one another by the partition members 250 and the cross members 260.

The battery cell stacks 400 may include first battery cell stacks 401 and second battery cell stacks 402 separated from each other by the cross members 260. Each of the battery cell stacks 400 may include a plurality of battery cells 410.

The battery cells 410 may extend in the second direction (in the Y direction or the direction opposite to the Y direction) and may be disposed in the first direction (in the X direction or the direction opposite to the X direction). The battery cells 410 may be implemented with a pouch-type lithium ion battery or a prismatic lithium ion battery, but are not limited thereto. The plurality of battery cells 410 may be accommodated in the battery housing 200 without a separate module frame.

That is, the battery cells 410 according to an exemplary embodiment of the present disclosure may be disposed in the battery pack 100 in a cell-to-pack (CTP) configuration. However, a method of mounting the battery cells 410 in the battery pack 100 is not limited thereto, and the battery cells 410 may be accommodated in the battery housing 200 using a separate module frame.

The battery cell stacks 400 may be disposed on the areas divided from one another by the partition members 250 and the cross members 260. The battery cell stacks 400 may be spaced apart from one another in the first direction (in the X direction or the direction opposite to the X direction) with the partition members 250 therebetween. The battery cell stacks 400 may include the first battery cell stacks 401 and the second battery cell stacks 4502 disposed parallel to each other in the second direction (in the Y direction or the direction opposite to the Y direction) with the cross members 260 therebetween.

Meanwhile, when the battery pack 100 is manufactured, the pack cover 300 may be coupled with the battery housing 200 after the battery cells 410 are disposed in the battery housing 200. Thereafter, the battery pack 100 may be disposed in an inverted state in the electric vehicle. In other words, the pack cover 300 may be disposed to face toward a road surface when the battery pack 100 is disposed in the electric vehicle.

The reason why the battery pack 100 is disposed in the inverted state in the electric vehicle is because, when a fire occurs in the battery pack 100, flames or high-temperature gases are able to be vented below the electric vehicle or it is advantageous in terms of protecting the battery cells 410.

In more detail, the battery pack 100 may be generally disposed under an occupant of the electric vehicle, and according to the structure in which the pack cover 300 is disposed toward the occupant, flames or high-temperature gases generated in the battery pack 100 may flow toward the occupant through the pack cover 300. In contrast, when the pack cover 300 is disposed in the electric vehicle to face toward the road surface, flames or high-temperature gases generated in the battery pack 100 may flow toward the road surface, and thus the safety of the occupant may be improved.

Furthermore, when the pack cover 300 of the battery pack 100 faces toward the occupant, the pack cover 300 may be damaged due to the weight of the occupant. In contrast, according to the structure in which the base cover 200 is disposed on one side of the battery housing 200 in the third direction (in a Z direction) so that the pack cover 300 faces toward the road surface and the pack cover 300 is disposed on an opposite side of the battery housing 200 in the third direction (in a direction opposite to the Z direction), impact due to the weight of the occupant may be applied to the base cover 210. In the instant case, the battery pack 100 may be damaged because the base cover 210 is more rigid than the pack cover 300.

Furthermore, due to the structure in which impact is transmitted to the base channel 211 of the base cover 210, the impact may be prevented from being transmitted to the battery cells 410 when the base cover 210 is damaged, as compared with when the pack cover 300 is damaged. Accordingly, damage to the battery cells 410 may be prevented.

As described above, when the battery pack 100 is disposed in the inverted state in the electric vehicle, the pack cover 300 may be disposed adjacent to the road surface, and the base cover 210 may be disposed adjacent to the user.

As illustrated in FIGS. 3 and 4, each of the battery cell stacks 400 may include a plurality of battery cells 410, surface pressure members 420, sensing assemblies 430, end plates 440, and plates 500.

The plurality of cells 410 may be contacting with the base cover 210 and may be disposed in the battery housing 200.

The surface pressure members 420 may be disposed between the plurality of battery cells 410 and may support the battery cells 410. The surface pressure members 420 may be disposed between the battery cells 410 and may be contacting with the battery cells 410.

The sensing assemblies 430 may be disposed on opposite sides in a direction perpendicular to the direction in which the plurality of battery cells 410 are stacked. The sensing assemblies 430 may include a sensing frame, a busbar, and a sensing board, and the busbar and the sensing board may be supported by the sensing frame and may be electrically connected to the battery cells 410.

The end plates 440 may be disposed on opposite sides in the direction in which the plurality of battery cells 410 are stacked. The end plates 440 and the surface pressure members 420 may provide surface pressure to the battery cells 410 to prevent a swelling phenomenon of the battery cells 410.

The battery cell stack 400 may include the plates 500 disposed between the battery cells 410 to alternate with the surface pressure members 420. The plates 500 may be components contacting with the battery cells 410 to cool the battery cells 410.

As illustrated in FIG. 5, the battery cell stack 400 may be contacting with the base cover 210. The plates 500 of the battery cell stack 400 may be contacting with the base cover 210. The plates 500 may absorb heat from the battery cells 410 and may transfer the heat to the base channel 211 of the base cover 210. The base cover 210 may exchange the heat with the plates 500.

As illustrated in FIG. 6, the plates 500 may be disposed between the plurality of battery cells 410, and each of the plates 500 may include a plate channel 510 through which cooling water distinguished from the cooling water flowing through the base channel 211 (refer to FIG. 11) flows. That is, the plate channel 510 and the base channel 211 may not be fluidically connected to each other. The plate channel 510 may be formed to be a closed passage through which the cooling water circulates.

Hereinafter, the second direction (the Y direction or the direction opposite to the Y direction) on the plate 500 is referred to as a longitudinal direction of the plate 500, and the third direction (the Z direction or the direction opposite to the Z direction) on the plate 500 is referred to as an up-down direction of the plate 500.

The plate channel 510 may absorb heat from the battery cells 410 and may release the heat to the base cover 210. The plate channel 510 may include a first heat-exchange area 520 that exchanges heat with the base cover 210 and a second heat-exchange area 530 that exchanges heat with the battery cells 410.

That is, the first heat-exchange area 520 may be an area for releasing heat to the base cover 210 or the outside thereof. In contrast, the second heat-exchange area 530 may be an area for absorbing heat from the battery cells 410.

The second heat-exchange area 530 may be disposed below the first heat-exchange area 520. In other words, the second heat-exchange area 530 may be disposed on the opposite side in the third direction (in the direction opposite to the Z direction) when compared to the first heat-exchange area 520.

In the instant case, the temperature of the cooling water flowing through the second heat-exchange area 530 may be higher than the temperature of the cooling water flowing through the first heat-exchange area 520. Due to the thermosyphon effect, the density of the cooling water flowing through the first heat-exchange area 520 may be higher than the density of the cooling water flowing through the second heat-exchange area 530.

Due to the density difference depending on temperature, the cooling water flowing through the first heat-exchange area 520 tends to flow downward, and the cooling water flowing through the second heat-exchange area 530 tends to flow upwards. Accordingly, the cooling water flowing through the first heat-exchange area 520 and the second heat-exchange area 530 may circulate on the plate 500.

In the battery pack 100, the first heat-exchange area 520 may be disposed outward of the second heat-exchange area 530. That is, on the plate 500, the first heat-exchange area 520 may be disposed closer to the side member 240 than the second heat-exchange area 530. In other words, on the plate 500, the second heat-exchange area 530 may be disposed closer to the cross member 260 than the first heat-exchange area 520.

The reason why the first heat-exchange area 520 is disposed outward of the second heat-exchange area 530 may be for easily releasing heat from the plate channel 510 to the outside of the electric vehicle when the cooling water flowing through the first heat-exchange area 520 exchanges heat with the outside air located outside in the width direction of the electric vehicle.

As compared with when the first heat-exchange area 520 only exchanges heat with the base cover 210, the heat dissipation effect of the first heat-exchange area 520 may be improved by the above-described structure.

As described above, the cooling water flowing through the plate channel 510 may be automatically circulated even without a separate external force while releasing heat through the first heat-exchange area 520 and absorbing heat through the second heat-exchange area 530. Accordingly, the temperature of the battery cells 410 may be adjusted even without a separate external force, and thus an outbreak of fire in the battery pack 100 and deterioration in the performance of the battery cells 410 may be prevented.

In more detail, the first heat-exchange area 520 may include one end portion 521 located on an upstream side of the first heat-exchange area 520 with respect to the flow direction of the cooling water and an opposite end portion 522 located on a downstream side of the first heat-exchange area 520 with respect to the flow direction of the cooling water.

To circulate the cooling water in the first heat-exchange area 520, the opposite end portion 522 of the first heat-exchange area 520 may be located on the one side in the third direction (in the Z direction) when compared to the one end portion 521 of the first heat-exchange area 520. That is, the opposite end portion 522 of the first heat-exchange area 520 may be disposed above the one end portion 521 of the first heat-exchange area 520.

Locally, the temperature of the cooling water flowing through the upstream side of the first heat-exchange area 520 may be higher than the temperature of the cooling water flowing through the downstream side of the first heat-exchange area 520. Accordingly, the density of the cooling water flowing through the upstream side of the first heat-exchange area 520 may be lower than the density of the cooling water flowing through the downstream side of the first heat-exchange area 520.

As a result, the flow of the cooling water in the first heat-exchange area 520 may be guided from the one end portion 521 of the first heat-exchange area 520 to the opposite end portion 522 of the first heat-exchange area 520.

Likewise, the second heat-exchange area 530 may include one end portion 531 located on an upstream side of the second heat-exchange area 530 with respect to the flow direction of the cooling water and an opposite end portion 532 located on a downstream side of the second heat-exchange area 530 with respect to the flow direction of the cooling water.

To circulate the cooling water in the second heat-exchange area 530, the opposite end portion 532 of the second heat-exchange area 530 may be located on the one side in the third direction (in the Z direction) when compared to the one end portion 531 of the second heat-exchange area 530. That is, the opposite end portion 532 of the second heat-exchange area 530 may be disposed above the one end portion 531 of the second heat-exchange area 530.

Likewise, the temperature of the cooling water flowing through the upstream side of the second heat-exchange area 530 may be lower than the temperature of the cooling water flowing through the downstream side of the second heat-exchange area 530. The density of the cooling water flowing through the upstream side of the second heat-exchange area 530 may be higher than the density of the cooling water flowing through the downstream side of the second heat-exchange area 530.

As a result, the flow of the cooling water in the second heat-exchange area 530 may be guided from the one end portion 531 of the second heat-exchange area 530 to the opposite end portion 532 of the second heat-exchange area 530. That is, as the cooling water flows through the second heat-exchange area 530, the temperature of the cooling water may be raised, and the density of the cooling water may be lowered. Thus, the flow of the cooling water flowing through the second heat-exchange area 530 may be guided.

The plate channel 510 may include a first connection area 540 that connects the one end portion 521 of the first heat-exchange area 520 and the opposite end portion 532 of the second heat-exchange area 530 and a second connection area 550 that connects the opposite end portion 522 of the first heat-exchange area 520 and the one end portion 531 of the second heat-exchange area 530.

The first connection area 540 may extend from the opposite end portion 532 of the second heat-exchange area 530 to the one end portion 521 of the first heat-exchange area 520 toward the side member 240. The first connection area 540 may extend in a horizontal direction on the plate 500. That is, the first connection area 540 may extend on the plate 500 in the longitudinal direction of the plate 500.

The second connection area 550 may extend from the opposite end portion 522 of the first heat-exchange area 520 to the one end portion 531 of the second heat-exchange area 530 toward the pack cover 300 and the cross member 260. The second connection area 550 may include a portion extending in an oblique direction from the opposite end portion 522 of the first heat-exchange area 520 to the second heat-exchange area 530 to form certain angles with the longitudinal direction of the plate 500 and the downward direction thereof.

According to the above-described structure, the first heat-exchange area 520 and the second heat-exchange area 530 may include a portion including a meandering shape along the up-down direction of the plate 500 or the longitudinal direction of the plate 500.

In the present way, the first heat-exchange area 520 and the second heat-exchange area 530 may secure a sufficient passage length for heat-exchange on the plate 500, so that the first heat-exchange area 520 may activate heat-exchange with the base cover 210 and the outside air and the second heat-exchange area 530 may activate heat-exchange with the battery cells 410.

The first heat-exchange area 520 and the second heat-exchange area 530 may include a meandering shape in the longitudinal direction of the plate 500 so that the passage length in the longitudinal direction of the plate 500 is secured.

The first heat-exchange area 520 and the second heat-exchange area 530 may include a portion extending in the longitudinal direction of the plate 500 and a portion formed in parallel in the up-down direction at least once.

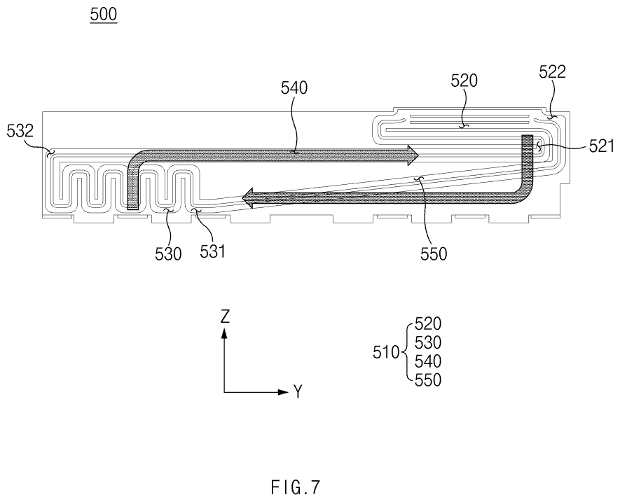

FIG. 7 is a front view of a plate according to another embodiment of the present disclosure.

Referring to FIG. 7, the plate 500 may include a shape corresponding to the shape of the plate 500 of FIG. 6, except that the plate 500 of FIG. 7 includes a second heat-exchange area 530 including a shape different from the shape of the second heat-exchange area 530 of the plate 500 of FIG. 6. Therefore, description of a first heat-exchange area 520, a first connection area 540, and a second connection area 550 of the plate 500 of FIG. 7 refers to the description of the first heat-exchange area 520, the first connection area 540, and the second connection area 550 of the plate 500 of FIG. 6.

Referring to FIG. 7, the second heat-exchange area 530 of the plate 500 may extend from one end portion 531 to an opposite end portion 531 in a meandering shape in the up-down direction thereof.

The first heat-exchange area 520 may include a portion extending in the longitudinal direction of the plate 500 and a portion formed in parallel in the up-down direction at least once. The second heat-exchange area 530 may include a portion extending in the up-down direction of the plate 500 and a portion formed in parallel in the longitudinal direction of the plate 500 at least once.

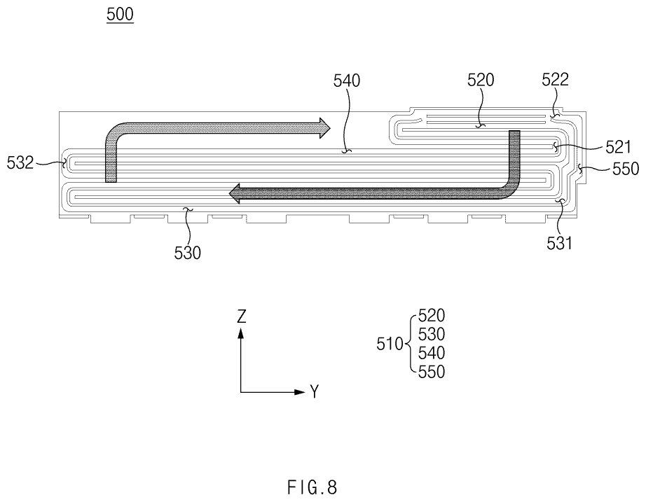

FIG. 8 is a front view of a plate according to another embodiment of the present disclosure.

Referring to FIG. 8, the plate 500 may include a first heat-exchange area 520 and a first connection area 540 that have shapes corresponding to the shapes of the first heat-exchange area 520 and the first connection area 540 of the plate 500 of FIG. 6. Therefore, description of the first heat-exchange area 520 and the first connection area 540 of the plate 500 of FIG. 8 refers to the description of the first heat-exchange area 520 and the first connection area 540 of the plate 500 of FIG. 6.

Referring to FIG. 8, a second heat-exchange area 530 of the plate 500 may include a portion extending on the plate 500 from one end portion to an opposite end portion in the longitudinal direction of the plate 500. In the instant case, a second connection area 550 of the plate 500 may include a portion extending in the up-down direction of the plate 500 along the one end portion of the plate 500 in the longitudinal direction.

The first heat-exchange area 520 and the second heat-exchange area 530 may include a portion extending in the longitudinal direction of the plate 500 and a portion formed in parallel in the up-down direction at least once.

In the case of the plate channels 510 of FIGS. 6 to 8 described above, the length of a passage is not relatively secured to the maximum, but cooling water may be smoothly circulated in the plate channels 510.

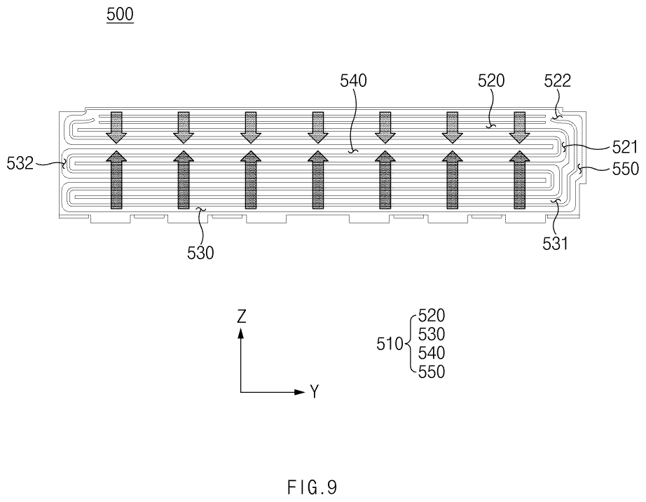

FIG. 9 is a front view of a plate according to another embodiment of the present disclosure.

Referring to FIG. 9, each of a first heat-exchange area 520 and a second heat-exchange area 530 may include a portion extending on the plate 500 from one end portion toward an opposite end portion in the longitudinal direction of the plate 500.

The first heat-exchange area 520 and the second heat-exchange area 530 may include a portion extending in the longitudinal direction of the plate 500 and a portion formed in parallel in the up-down direction at least once.

In the instant case, a first connection area 540 may extend in the longitudinal direction of the plate 500, and a second connection area 550 may extend in the up-down direction of the plate 500.

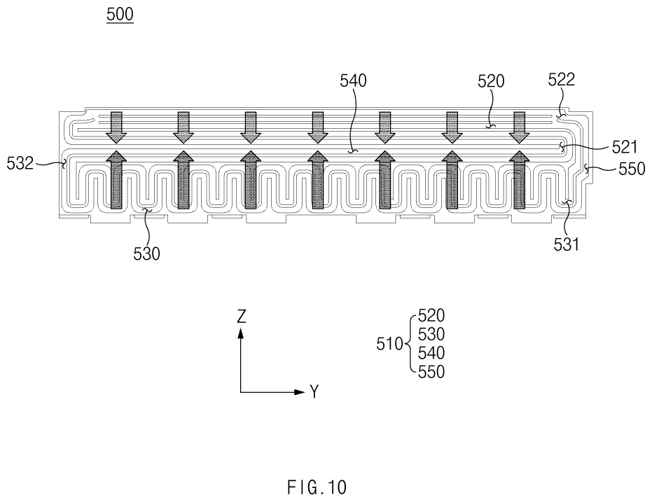

FIG. 10 is a front view of a plate according to another embodiment of the present disclosure.

Referring to FIG. 10, each of a first heat-exchange area 520 and a second heat-exchange area 530 may include a portion extending on the plate 500 from one end portion toward an opposite end portion in the longitudinal direction of the plate 500.

The first heat-exchange area 520 may include a portion extending in the longitudinal direction of the plate 500 and a portion formed in parallel in the up-down direction of the plate 500 at least once. The second heat-exchange area 530 may include a portion extending in the up-down direction of the plate 500 and a portion formed in parallel in the longitudinal direction of the plate 500 at least once.

In the instant case, a first connection area 540 may extend in the longitudinal direction of the plate 500, and a second connection area 550 may extend in the up-down direction of the plate 500.

The plates 500 of FIGS. 9 and 10 may include the first heat-exchange area 520 or the second heat-exchange area 530 having a longer passage length than the first heat-exchange areas 520 or the second heat-exchange areas 530 of the plates 500 of FIGS. 6 to 8, and thus plate channels 510 of FIGS. 9 and 10 may smoothly absorb and release heat.

FIG. 11 is a vertical sectional view of the battery pack taken along line A-A′ illustrated in FIG. 1. FIG. 12 is a vertical sectional view of the battery pack taken along line perpendicular to line A-A′ illustrated in FIG. 1.

Referring to FIGS. 11 and 12, the plurality of battery cell stacks 400 may include the first battery cell stacks 401 disposed between one of the pair of side members 240 and the cross members 260 and the second battery cell stacks 402 disposed between the other one of the pair of side members 240 and the cross members 260.

The plate channels 510 (refer to FIG. 6) of the plates 500 disposed between a first plurality of battery cells stacked in the first battery cell stacks 401 and the plate channels 510 (refer to FIG. 6) of the plates 500 disposed between a second plurality of battery cells stacked in the second battery cell stacks 402 may be disposed to be symmetrical to each other with respect to the cross members 260.

That is, the first heat-exchange areas 520 of the plates 500 belonging to the first battery cell stacks 401 and the first heat-exchange areas 520 of the plates 500 belonging to the second battery cell stacks 402 may be disposed adjacent to the base cover 210 and the side members 240.

Furthermore, the second heat-exchange areas 530 of the plates 500 belonging to the first battery cell stacks 401 and the second heat-exchange areas 530 of the plates 500 belonging to the second battery cell stacks 402 may be disposed adjacent to the pack cover 300 and the cross members 260.

The base cover 210 may be disposed on the upper side of the plate channels 510, and the pack cover 300 may be disposed on the lower side of the plate channels 510. The gap fillers 212 may be disposed between the base cover 210 and the plates 500, and the base channel 211 may be disposed inside the base cover 210.

Accordingly, the heat of the cooling water flowing in the plate channels 510 may be transferred to the cooling water flowing in the base channel 211 through the gap fillers 212, and thus the temperature of the battery cells 410 may be adjusted.

Due to the disposed configuration, an outbreak of fire in the battery pack 100 and deterioration in the performance of the battery pack 100 may be prevented.

As described above, due to the density difference depending on temperature, the cooling water may be automatically circulated through the plate channel on the plate disposed between the battery cells. Accordingly, the heat of the battery cells may be automatically exchanged, and thus an outbreak of fire in the battery cells may be prevented.

The first heat-exchange area may be disposed above the second heat-exchange area. Accordingly, the cooling water flowing through the plate channel may be circulated even without an external force due to the thermosyphon effect.

The first heat-exchange area may be disposed closer to the base cover than the second heat-exchange area. Accordingly, heat-exchange between the first heat-exchange area and the base cover may be guided.

The first heat-exchange area may be disposed closer to the side member than the second heat-exchange area. Accordingly, heat-exchange between the first heat-exchange area and the outside may be guided.

Furthermore, the present disclosure may provide various effects that are directly or indirectly recognized.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

What is claimed is:

1. A battery pack comprising:
a base cover;
a plurality of battery cells contacting with the base cover; and
a plate disposed between the plurality of battery cells and including a plate channel through which cooling water flows,
wherein the plate channel includes:
a first heat-exchange area exchanging heat with the base cover; and
a second heat-exchange area disposed on an one side of the first heat-exchange area in an up-down direction of the plate and exchanging heat with the battery cells.

2. The battery pack of claim 1, wherein the plate channel is formed to be a closed passage through which the cooling water circulates.

3. The battery pack of claim 1, wherein the first heat-exchange area includes:
one end portion located on an upstream side of the first heat-exchange area with respect to a flow direction of the cooling water; and
an opposite end portion located on a downstream side of the first heat-exchange area with respect to the flow direction of the cooling water, and
wherein the one end portion and the opposite end portion are fluidically-connected to each other and the opposite end portion of the first heat-exchange area is disposed on an one side of the one end portion of the first heat-exchange area in the up-down direction of the plate.

4. The battery pack of claim 1, wherein the second heat-exchange area includes:
one end portion located on an upstream side of the second heat-exchange area with respect to a flow direction of the cooling water; and
an opposite end portion located on a downstream side of the second heat-exchange area with respect to the flow direction of the cooling water, and
wherein the one end portion and the opposite end portion are fluidically-connected to each other and the opposite end portion of the second heat-exchange area is disposed on an one side of the one end portion of the second heat-exchange area in the up-down direction of the plate.

5. The battery pack of claim 1, further comprising:
a side member covering one side of the plurality of battery cells,
wherein the first heat-exchange area is disposed closer to the side member than the second heat-exchange area on the plate.

6. The battery pack of claim 1, further comprising:
a cross member contacting with the base cover and extending to cross a space in which the plurality of battery cells is disposed,
wherein the second heat-exchange area is disposed closer to the cross member than the first heat-exchange area on the plate.

7. The battery pack of claim 5,
wherein the side member is disposed in a pair,
wherein the battery pack further includes a cross member disposed between the pair of side members and extending to cross a space in which the plurality of battery cells is disposed,
wherein the plurality of batter cells include:
a first plurality of battery cells disposed between one of the pair of side members and the cross member; and
a second plurality of battery cells disposed between the other one of the pair of side members and the cross member, and
wherein the plate channel of the plate disposed between the first plurality of battery cells and the plate channel of the plate disposed between the second plurality of battery cells are disposed to be symmetrical to each other with respect to the cross member.

8. The battery pack of claim 3, wherein the plate channel further includes:
a first connection area connecting the one end portion of the first heat-exchange area and the second heat-exchange area; and
a second connection area connecting the opposite end portion of the first heat-exchange area and the second heat-exchange area.

9. The battery pack of claim 8, wherein the first connection area extends in a horizontal direction of the battery pack.

10. The battery pack of claim 8, wherein the second connection area includes a portion extending in an oblique direction from the opposite end portion of the first heat-exchange area to the second heat-exchange area to form predetermined angles with a longitudinal direction of the plate and the up-down direction of the plate.

11. The battery pack of claim 1, wherein the first heat-exchange area includes a portion including a meandering shape in the up-down direction of the plate or a longitudinal direction of the plate.

12. The battery pack of claim 1, wherein the second heat-exchange area includes a portion including a meandering shape in the up-down direction of the plate or a longitudinal direction of the plate.

13. The battery pack of claim 1, wherein the first heat-exchange area includes a portion extending from one end portion thereof in a longitudinal direction of the plate toward an opposite end portion thereof in the longitudinal direction of the plate on the plate.

14. The battery pack of claim 1, wherein the second heat-exchange area includes a portion extending from one end portion thereof in a longitudinal direction of the plate toward an opposite end portion thereof in the longitudinal direction of the plate on the plate.

15. The battery pack of claim 1, wherein the second heat-exchange area extends from one end portion thereof in a longitudinal direction of the plate to an opposite end portion thereof in the longitudinal direction of the plate in a shape meandering in the up-down direction on the plate.

16. The battery pack of claim 1, wherein the base cover is disposed on an one side of the plate channel in the up-down direction of the plate.

17. The battery pack of claim 1, wherein the base cover includes a base channel formed therein.

18. The battery pack of claim 1, further including surface pressure members disposed between the plurality of battery cells and supporting the battery cells.
